(19) United States
(12) Patent Application Publication
(10) Pub. No.: US 2026/0233402 A1
(43) Pub. Date: Aug. 13, 2026

(54) COORDINATE POSITIONING MACHINE

(71) Applicant: RENISHAW PLC, Wotton-Under-Edge, Gloucestershire (GB)

(72) Inventors: Julius Benjamin DUPREZ, Champs sur Marne (FR); Jean-Louis GRZESIAK, Champs sur Marne (FR); Kevin PRUNENEC, Champs sur Marne (FR)

(73) Assignee: RENISHAW PLC, Wotton-Under-Edge, Gloucestershire (GB)

(21) Appl. No.: 19/148,237

(22) PCT Filed: Jan. 25, 2024
(86) PCT No.: PCT/GB2024/050196

§ 371 Date: Jul. 15, 2025

(30) Foreign Application Priority Data
Jan. 26, 2023 (FR) 23/00745

(51) Int. Cl. B25J 9/16; G01B 21/04

(52) U.S. Cl. CPC B25J 9/1692; G01B 21/04

(57) ABSTRACT

A method is disclosed of calibrating or otherwise characterising a coordinate positioning machine having a first member that is moveable relative to a second member. One or more length-measuring devices is/are coupled in a plurality of different configurations between at least one support mounted on the first member and a plurality of supports mounted on the second member via a base plate 22. For each of the plurality of different configurations, the machine is controlled to move the first member relative to the second member to collect calibration data. The geometry of the machine is characterised by a set of model parameters, and the calibration data are used to determine a better estimate for at least one of the model parameters.

The present invention relates to a coordinate positioning machine. The present invention relates in particular, but not exclusively, to a system for calibrating or otherwise characterising at least some aspect of a coordinate positioning machine. The present invention is particularly applicable, for example, to a non-Cartesian type of coordinate positioning machine, such as a hexapod, measurement arm or articulated robot.

Articulated robots are commonly used in a wide variety of manufacturing applications such as assembly, welding, gluing, painting, picking and placing (e.g. for printed circuit boards), packaging and labelling, palletizing, and product inspection. They benefit from being versatile and rugged, with a large reach and a high degree of flexibility of movement, making them ideal for use in a production environment.

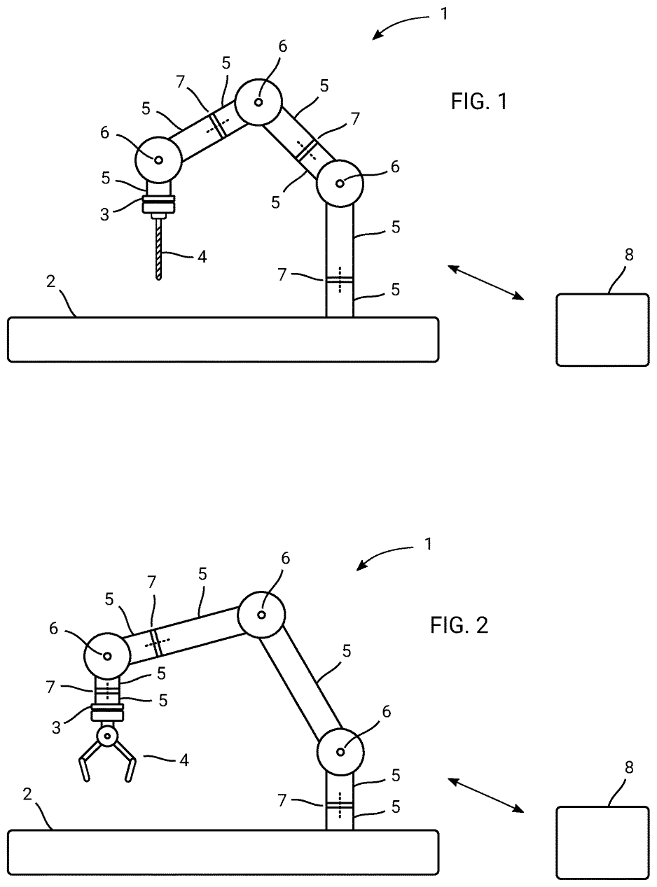

An articulated robot (or just “robot” for short) is illustrated schematically in FIG. 1 of the accompanying drawings, comprising an articulated robot arm 1 extending from a fixed base 2 to a moveable flange 3, with the flange 3 supporting a tool (or end effector) 4. The tool 4 in FIG. 1 is a drilling tool. Typically, the flange 3 is provided with a coupling which allows for the tool 4 to be conveniently interchangeable, so that a variety of tools or end effectors can be employed depending on the application concerned; examples include grippers, vacuum cups, cutting tools (including both mechanical and laser cutting tools), drilling tools, milling tools, deburring tools, welding tools and other specialized tools. The flange 3 can also referred to more generally as the “head” of the robot arm 1, with the fixed base 2 being the “base”, and with the robot arm 1 being controlled to move the head relative to the base by commands from a machine controller 8. The flange 3 is also sometimes referred to as the “hand” of the robot arm 1.

The arm 1 comprises a plurality of segments 5 connected by a mixture of transverse rotary axes 6 and inline (or longitudinal) rotary axes 7, forming a mechanical linkage from one end to the other. In the example illustrated in FIG. 1, there are three transverse rotary axes 6 and three inline rotary axes 7, making a total of six rotary axes, alternating between transverse rotary axes 6 and inline rotary axes 7. An additional inline rotary axis 7 (not shown in FIG. 1) could also be provided between the final transverse rotary axes 6 and the flange 3, to provide convenient rotation of the tool 4 around its longitudinal axis, making a total of seven rotary axes. In general, rotary axes of a robot need not be exactly orthogonal or exactly longitudinal but can be arranged at any desired angle.

Another common arrangement is shown in the arm 1 of FIG. 2, which includes the additional inline rotary axis 7 mentioned above, between the final transverse rotary axis 6 and the flange 3, and which also omits the second inline rotary axis 7 from FIG. 1 (in series order from the base end to the head end), thereby making a total of six rotary axes. The tool 4 in FIG. 2 is a gripper. The arm 1 of FIG. 2 is a schematic representation of the well-known IRB 140 six-axis industrial robot by ABB Robotics. The final three axes 6, 7 form a “wrist” of the robot arm 1, with the centre of the wrist being at the centre of the final transverse rotary axis 6. The centre of the wrist is invariant to rotation of the three rotary axes 6, 7 of the wrist, such that operation of the three rotary axes 6, 7 changes the orientation of whatever is attached to the wrist (in this case the gripper 4) without changing the position of the wrist centre, with the first three rotary axes 6, 7 of the robot arm 1 determining the position of the wrist centre. The wrist may be readily detachable from the remainder of the arm 1.

The articulated robot arms 1 of FIGS. 1 and 2 are examples of a non-Cartesian coordinate positioning machine because, in contrast to a Cartesian machine such as a traditional three-axis (X, Y, Z) coordinate measuring machine (see for example FIG. 1 of WO 2021/074625 A1), its axes are not arranged orthogonally according to a Cartesian coordinate system. The arms 1 of FIGS. 1 and 2 are also examples of a “serial kinematic” coordinate positioning machine, because their axes of movement are arranged in series. In this sense, such a machine is similar to a traditional three-axis Cartesian coordinate measuring machine, which is also an example of a “serial kinematic” coordinate measuring machine, and is to be contrasted with a “parallel kinematic” coordinate positioning machine such as a hexapod whose axes of movement are arranged instead in parallel.

Each joint or axis in a coordinate positioning machine contributes a positional error or uncertainty. In a serial kinematic machine such as that shown in FIGS. 1 and 2, because of the serial nature of the linkages, these errors are cumulative. Whilst this accumulation of positional errors does not occur in the same sense with a parallel kinematic machine, regardless of machine type it is important to calibrate the machine in order to map out these errors or uncertainties.

Calibration of any type of non-Cartesian machine is a significant challenge, and particularly so for an articulated arm such as that illustrated in FIGS. 1 and 2 having a plurality of rotary axes that are: (a) arranged in series; (b) are not fixed relative to one another; and (c) that can combine in complicated ways to position the tool in the working volume. Calibration of a Cartesian machine is typically more straightforward, because such a machine has three well-defined axes that are fixed relative to one another in an orthogonal arrangement, with each axis being largely independent of another. With an articulated robot, the position and orientation of each axis depends on the position and orientation of each other axis, so that the calibration will be different for each different machine pose.

Many calibration techniques have in common the goal of specifying a parametric model of the machine concerned, in which a set of model parameters (also referred to as machine parameters or kinematic parameters) is used to characterise the machine's geometry. Uncalibrated values are initially assigned to these parameters as a starting point for the machine geometry. During the calibration, the machine is moved into a variety of different poses (based on the current estimates of the machine parameters). For each pose, a calibrated measuring device is used to measure the actual pose, so that an indication of the error between the assumed machine pose and the actual machine pose can be determined.

The task of calibrating the machine then amounts to determining a set of values for the various machine parameters that minimises the errors, using known numerical optimisation or error minimisation techniques. An example of such a technique is the well-known Levenberg-Marquardt algorithm, which uses a least-squares approach to minimise errors knowing the derivatives of the errors according to each parameter optimised (“A Method for the Solution of Certain Non-Linear Problems in Least Squares”, Kenneth Levenberg, 1944, Quarterly of Applied Mathematics, 2: 164-168; and “An Algorithm for Least-Squares Estimation of Nonlinear Parameters”, Donald Marquardt, 1963, SIAM Journal on Applied Mathematics, 11 (2):431-441). Other techniques are also possible, including those based on a maximum likelihood approach.

For a robot arm as illustrated in FIGS. 1 and 2, these machine parameters might include various geometrical parameters such as the length of each of the segments 5 and the rotation angle offset of each of the rotary axes or joints 6, 7 (with the angle from the encoder plus the calibrated offset giving the actual angle), as well as various mechanical parameters such as joint compliance and friction. The machine parameters might also include the offset coordinates of the working point of the tool, such as the tip of the drilling tool 4 of FIG. 1, relative to the head or flange 3. In this respect, the offset of the working point (or tool centre point) is an important piece of information, and this will be discussed in more detail below.

When properly calibrated, with all of these machine parameters known, it is possible to predict with more certainty in what position the working point (or tool centre point) of the tool 4 will actually be when the various axes or joints 6, 7 are commanded by the controller 8 to move to different respective positions. In other words, the machine parameters resulting from such a calibration provide a more accurate characterisation of the machine geometry. These concepts, relating to calibration of coordinate positioning machines in general, and robot arms in particular, are explored in greater detail in WO 2019/162697 A1 and WO 2021/116685 A1.

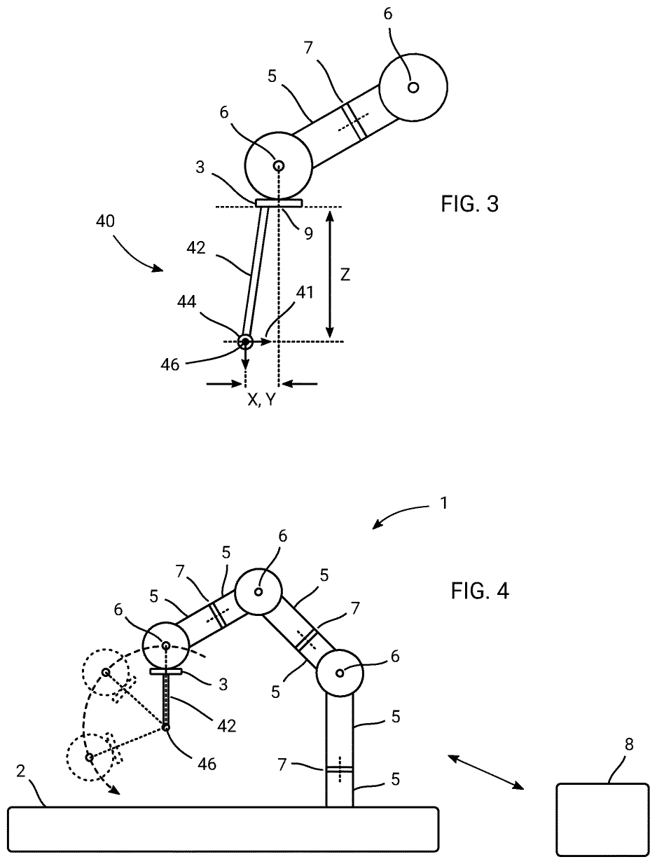

FIG. 3 of the accompanying drawings shows a schematic representation of a tool 40 attached to a flange 3 of a robot arm of a type as described above with reference to FIGS. 1 and 2. The tool 40 has an elongate member 42 that is mounted at an angle to the flange 3 (the mounting angle may be deliberate or it could be inadvertent), with a tip 44 at a distal end of the elongate member 42. The centre 46 of the tip 44 is a particular point of interest because it would typically be the working point of the tool 40, or some other important reference point associated with the tool 40, and in a robot architecture this is commonly referred to as the tool centre point or TCP of the tool 40.

When programming a robot to move the tool 40 around the working volume, the location of the tool centre point 46 relative to the part of the robot to which the tool 40 is attached, i.e. the flange 3 in this case, is an important piece of information. Specifying the coordinates or offset (X, Y, Z) of the tool centre point 46 is a key step when setting up any robot for operational use. The tool centre point 46 is the point in relation to which all robot positioning is defined, and constitutes the origin of the tool frame (or tool coordinate system) 41. The tool centre point 46 might correspond, for example, to the tip of an arc welding gun, the centre of a spot welding gun, the end of a grading tool, or the tip of a drilling tool such as that shown in FIG. 1. The location of the tool centre point 46 will therefore depend on the application concerned.

It is to be noted that knowledge of the coordinates or offset of the tool centre point 46 does not imply knowledge of the orientation of the tool 40 relative to the flange 3, nor does it imply knowledge of the length of the tool 40, because the tool centre point 46 is defined relative to an arbitrary point (or frame of reference) 9 on the flange 3 that is known and defined internally, and this does not necessarily correspond to the point at which the elongate member or shaft 42 of the tool 40 is actually attached to the flange 3, as indeed is the case in the schematic example shown in FIG. 3. Therefore, determining the tool centre point 46 of the tool 40 is not the same as, and does not amount to, determining the orientation or direction or length or size of the tool 40.

In operation, it is the tool centre point 46 that will be jogged around or moved to the desired target position with the desired tool orientation. For example, with reference to the “wrist” concept for a robot arm of a type as described above with reference to FIG. 2, the first three rotary axes of the robot arm can be controlled to set the position of the wrist centre, the three rotary axes of the wrist can be used to change the orientation of the flange 3 relative to the first three axes, and the position of the key point of the working tool 40 relative to the flange 3 can be determined from the tool centre point (TCP) information. By knowing and controlling these aspects of the robot architecture, the position of the working point 46 of the tool 40 can be controlled in a relatively straightforward manner.

FIG. 4 of the accompanying drawings schematically illustrates the robot arm 1 being instructed by the controller 8 to move the tool 40 so that the tool centre point 46 of the tool 40 remains in the same position, or at least should ideally remain in the same position. Such a test is typically performed to verify that the tool centre point 46 has been correctly identified and is sometimes known as a “tool orientation test”. The objective is to assess the robot's accuracy (and the accuracy of the coordinates X, Y, Z of the tool centre point 46 as shown in FIG. 3) by measuring its ability to rotate around the tool centre point 46 that is programmed into the controller 8, ideally without any actual movement of the tool centre point 46 being apparent when the test is being performed.

Rather than merely verify the position of the TCP as is done with the tool orientation test, several methods exist for determining the absolute position of the TCP. The most common method currently is the pin-to-pin method in which the operator visually aligns two pins with different orientations, one of which is fixed on the machine base and the other of which is moveable by the robot to reference the TCP, with the robot being controlled manually by an operator. This is a convenient method, but it is relatively inaccurate because it depends to a large extent on the skill and experience of the operator; it also requires the tool 40 to be removed and replaced by the pin. Other known methods can be very costly to implement, such as those that make use of non-contact measurement systems like a camera-based system, a laser scanner, and so on, or measuring the robot tool with a touch probe. Those methods are of a type to determine values for the TCP coordinates as part of a full calibration of the robot, including the TCP offset.

A full calibration routine as described above can be complicated and time consuming, particularly where only a subset of the machine parameters is required. As noted in “An Automated Method to Calibrate Industrial Robot Joint Offset Using Virtual Line-based Single-point Constraint Approach” (by Liu et al, DOI:10.1109/IROS.2009.5354312, 2009 IEEE/RSJ International Conference on Intelligent Robots and Systems, Oct. 11-15, 2009 St. Louis, USA), some machine parameters such as joint offsets might need to be updated frequently, for example every time a motor or a rotary encoder in a rotary joint has been replaced or adjusted. In this respect, a joint offset relates to the offset or error between the home reference position for the joint according to the parametric (or kinematic) model of the robot, and the actual reading or signal from the relevant rotary encoder of the robot itself. A joint offset can be considered to define a fixed offset value to be added to the angle reported by the rotary encoder for the joint concerned. The positioning accuracy of the robot can be affected significantly by only small changes to the joint offsets. According to previous studies referenced in Liu et al, more than 90% of the positioning inaccuracy of an industrial robot can be attributed to errors associated with these joint offsets.

Therefore, the present applicant has appreciated that calibration of these joint offsets is an important task for any serial kinematic machine having rotary joints, such as a robot arm described above.

According to a first aspect of the present invention there is provided a method of calibrating or otherwise characterising a coordinate positioning machine having a first member that is moveable relative to a second member, wherein the geometry of the machine is characterised by a set of model parameters, and wherein the method comprises: (a) coupling one or more length-measuring devices in a plurality of different configurations between at least one support mounted on the first member and a plurality of supports mounted on the second member; (b) for each of the plurality of configurations, controlling the machine to move the first member relative to the second member (e.g. into a plurality of positions or poses) to collect calibration data (e.g. for each of the positions or poses); and (c) using the calibration data to determine a better estimate for and/or updating at least one of the model parameters.

According to an embodiment of the present invention there is provided a method of calibrating or characterising at least one joint offset of a coordinate positioning machine such as a robot arm having a plurality of rotary joints arranged in series between a base end and a head end. The method according to this embodiment involves coupling up to three measurement struts in different configurations between a moveable support and a triangular arrangement of fixed supports, controlling the machine to move the moveable support to collect calibration data in each configuration, and using the calibration data to determine a better estimate for the at least one joint offset. The measurement struts may be referred to more generally as length-measuring devices.

The method can be used to characterise a plurality of joint offsets of the coordinate positioning machine, such as all of the joint offsets. The coordinate positioning machine may be a robot arm. Two or more measurement struts (e.g. two or three measurement struts) may be used in at least some configurations, or in all configurations. Where more than two measurement struts are used in a configuration, the two or more measurement struts may be coupled between the relevant supports together (or at the same time), i.e. rather than a single measurement strut being coupled in turn between different pairs of supports to replicate the configuration. Fewer than three measurement struts (e.g. one or two measurement struts) may be used in at least some configurations, or in all configurations.

Using a plurality of measurement struts in this way, combining them in a flexible manner to achieve a broad range of joint movement, enables a more accurate and/or effective calibration or characterisation of the joint offsets to be performed, particularly for those joint offsets that are closest to the base end of a serial kinematic coordinate positioning machine such as a robot arm. The procedure is also relatively straightforward and to perform, and relatively inexpensive in comparison to other known systems and procedures.

The length-measuring device may have a coupling element at each end which is adapted to couple to and bear against the bearing surface of a spherical support such that a measurement point of the measuring device is coincident with or is a known offset from the centre of the spherical support, and remains so as the coupling element moves over at least a predetermined or working part of the bearing surface.

The length-measuring device may be adapted to provide a measurement of the separation between two measurement points of the device (or a measurement of changes in this separation). The measurement point may be at the centre of a ball at an end of the measuring device or a ball to which the measuring device couples. The coupling element may be in the form of a cup. The measuring device may have a ball at one end and a cup at the other end, or a cup at both ends, with the cup being adapted to couple with the at least part spherical surface of the adaptor.

The coupling may be kinematic or at least pseudo kinematic. The measuring device may be a measurement strut.

The moveable support (i.e. that which is moved by the machine) and the fixed supports may each be spherical or at least part-spherical, having a spherical or at least part-spherical bearing surface onto which a coupling element of the length-measuring device can couple.

A different arrangement of moveable and fixed supports may be used than described above. For example, there could be an artefact having three supports that is moved by the machine, with a single fixed support. A different number of fixed supports and moveable supports could also be used (i.e. other than 3-1 or 1-3, for example 3-2 or 2-3 or 3-3), with a corresponding number of measurement struts. In general, it has not previously been proposed to the use a plurality of measurement struts, in a flexible manner, to calibrate or otherwise characterise joint offsets of a coordinate positioning machine such as a robot arm.

The method may also be applied to the calibration or characterisation of other model parameters of the coordinate positioning machine, as well as or instead of the calibration or characterisation of the at least one joint offset.

Regarding step (a) of the method, each configuration may comprise (or may be made up of) one or more length-measuring devices coupled between a different combination of supports (compared to each other configuration).

At least one configuration (e.g. all configurations) may comprise (or may be made up of) a different number of length-measuring devices to at least one other configuration.

At least configuration (e.g. all configurations) may comprise (or may be made up of) the same number of length-measuring devices to at least one other configuration but coupled between a different combination of supports.

Regarding step (b) of the method, the relative movements between the first and second members performed for each configuration may be different to those performed for at least one other configuration (e.g. all other configurations).

The model parameters may comprise at least one joint offset, and step (c) may comprise using the calibration data to determine a better estimate for the at least one joint offset. The method may be used to calibrate or characterise a plurality of joint offsets, such as all of the joint offsets.

At least one configuration may be made up of a plurality of length-measuring devices which are coupled between the relevant supports at the same time.

Where at least one configuration is made up of a plurality of length-measuring devices, at least two of the length-measuring devices making up the configuration may be coupled between the relevant supports at different times (as different subsets of the length-measuring devices, with each subset comprising one or more length-measuring devices), with the same movements being performed for each of these length-measuring devices (or subset of length-measuring devices). In doing so, this effectively replicates a configuration in which the same movements are made with all length-measuring devices coupled between the relevant supports at the same time. Reference herein to a configuration having (or being made up of) a certain number of length-measuring devices (for example three length-measuring devices) should be understood in this context, such that it is not a requirement that all of these length-measuring devices are coupled between the relevant supports at the same time.

Step (a) of the method may comprise coupling up to three length-measuring devices in a plurality of different configurations between a single support mounted on the first member and a triangular arrangement of three supports mounted on the second member.

Step (a) of the method may comprise coupling up to six length-measuring devices in a plurality of different configurations between a triangular arrangement of three supports mounted on the first member and a triangular arrangement of three supports mounted on the second member.

At least one of the configurations (for example all of the configurations) may have two or more length-measuring devices coupled between the supports.

At least one of the configurations may have more than one length-measuring device and fewer than six length-measuring devices coupled between the supports.

At least one of the configurations may have fewer than three length-measuring devices coupled between the supports.

At least one of the configurations may have (exactly) a single length-measuring device coupled between the supports.

Each of the configurations may have (exactly) a single length-measuring device coupled between the supports. Each of the configurations may have (exactly) two length-measuring devices coupled between the supports. Each of the configurations may have (exactly) three length-measuring devices coupled between the supports.

At least one of the configurations may have (exactly) two length-measuring devices coupled at the same time (in a triangular configuration) between the supports.

At least one of the configurations may have (exactly) three length-measuring devices coupled at the same time (in a tripod configuration) between the supports.

Where there is more than one support mounted on the relevant (i.e. first or second) member, the supports may be mounted (on the member concerned) in a fixed position relative to one another (in a known or measured or calibrated geometrical relationship to one another).

The relative positions between the supports (on the member concerned) may be measured using another coordinate measuring machine (thereby characterising the geometry of the arrangement of supports) and this relative positional information may be used in step (c).

The method may comprise measuring the relative positions between the supports (on the member concerned) using one or more of the length-measuring devices (thereby characterising the geometry of the arrangement of supports).

The supports (on the member concerned) may be arranged relative to one another such that the geometry of the arrangement of supports can be (completely) characterized by measurements between different pairs of the supports that are within a measuring range of the length-measuring devices used in the method. In other words, the separation between these pairs of supports may be within a measuring range of the length-measuring devices.

The supports (on the member concerned) may be mounted in a non-planar (or three-dimensional) arrangement relative to one another, for example in a tetrahedral arrangement.

Each length-measuring device may be adapted to provide a measurement of the separation between two measurement points of the device, or at least a measurement of changes in this separation.

The measurement point may be at the centre of a ball at an end of the measuring device or a ball to which the measuring device couples.

Each support may have an at least part-spherical bearing surface and each length-measuring device may have a coupling element at each end which is adapted to couple to and bear against the bearing surface of the corresponding support. In this way, a measurement point of the measuring device would be coincident with or be a known offset from the centre of the at least part-spherical bearing surface and would remain so as the coupling element moves over at least a predetermined or working part of the bearing surface.

Each length-measuring device may have a limited range of movement and/or measurement.

Each length-measuring device may be of the same type, for example with the same limited range of movement and/or measurement.

Each length-measuring device may be or may comprise a measurement strut or ballbar and/or could be based on a cable system or an interferometric measurement system.

The calibration data may comprise measurement data (e.g. lengths or separations) from the length-measuring devices.

The calibration data may comprise machine coordinate data.

Calibrating or otherwise characterising the machine may comprise one or more of calibrating, verifying, certifying and checking the performance of the machine.

The coordinate positioning machine may be a non-Cartesian and/or parallel kinematic machine.

The coordinate positioning machine may be a robot arm (or an articulated arm such as a robot arm).

The robot arm may comprise a plurality of rotary joints arranged in series between a base end and a head end.

The coordinate positioning machine may be a hexapod.

The first member may be a moving member of the machine, such as an end effector or spindle or flange of a robot arm.

The second member may be a fixed member of the machine, such as a fixed platform or bed.

Step (c) of the method may comprise determining a new set of model parameters which would fit the calibration data (e.g. recorded lengths and/or separations) better than the existing set of model parameters, for example based on an objective function.

Step (c) of the method may comprise determining an overall error value representing the expected lengths/separations and updating at least one model parameter to reduce the overall error value.

Step (c) of the method may comprise iteratively updating the at least one model parameter until a predetermined test is met.

The model parameters may comprise a plurality of tool frame parameters, and step (c) may comprise updating at least three of the tool frame parameters, for example three tool frame parameters defining the position of a tool centre point.

The model parameters may comprise a plurality of part frame parameters, wherein step (c) may comprise updating at least three of the part frame parameters, for example three part frame parameters defining the position of a point of interest of the part frame.

Step (c) of the method may comprise determining a new value or new values for only a subset of the model parameters (or could comprise determining new values for most or even all of the model parameters).

According to a second aspect of the present invention, there is provided a method of checking and/or updating the tool or part frame of a tool or part mounted to a coordinate positioning machine such as a robot arm, comprising performing a method according to the first aspect, and wherein step (c) comprises checking and/or updating one or more parameters of the tool or part frame.

According to a third aspect of the present invention, there is provided a set of instructions which, when carried out (for example by an operator), causes a method according to the first aspect to be performed. The instructions may be in printed or electronic form or a combination of these. The instructions may form part of an operator manual. The instructions may be provided on a display by a computer program.

According to a fourth aspect of the present invention, there is provided a kit (for example a calibration kit) for use in a method according to the first aspect, the kit comprising the one or more length-measuring devices, a first support arrangement comprising the at least one support to be mounted on the first member of the machine, and a second support arrangement (or calibration artefact) comprising the plurality of supports to be mounted on the second member of the machine. The kit may comprise a set of instructions according to the third aspect or at least a link to or information regarding how to obtain such a set of instructions.

According to a fifth aspect of the present invention, there is provided a support arrangement (or calibration artefact) for use in a method according to the first aspect, the support arrangement (or calibration artefact) comprising the plurality of supports to be mounted on the second member of the machine.

According to a sixth aspect of the present invention, there is provided a computer program which, when run by a computer or a machine controller, causes the computer or machine controller to perform one or more steps of a method according to the first aspect, for example one or both of steps (b) and (c).

According to a seventh aspect of the present invention, there is provided a computer-readable medium having stored therein computer program instructions for controlling a computer or a machine controller to perform one or more steps of a method according to the first aspect, for example one or both of steps (b) and (c).

According to an eighth aspect of the present invention, there is provided a computer or machine controller configured to perform one or more steps of a method according to the first aspect, for example one or both of steps (b) and (c).

According to a ninth aspect of the present invention, there is provided a system for calibrating or otherwise characterising a coordinate positioning machine comprising means for performing one or more steps of a method according to the first aspect, for example one or both of steps (b) and (c).

According to a tenth aspect of the present invention, there is provided a method of controlling a coordinate positioning machine which has been calibrated or otherwise characterised using a method according to the first aspect.

According to an eleventh aspect of the present invention, there is provided a coordinate positioning machine which has been calibrated or otherwise characterised using a method according to the first aspect.

Reference will now be made, by way of example, to the accompanying drawings, in which:

FIG. 1, discussed hereinbefore, is a schematic illustration of a coordinate positioning arm in the form of an articulated robot, and carrying a drilling tool;

FIG. 2, also discussed hereinbefore, is a schematic illustration of an articulated robot having a different arrangement of rotary axes to that of FIG. 1, and carrying a gripping tool;

FIG. 3, also discussed hereinbefore, is a schematic diagram for use in illustrating and describing in more detail the concept of a tool centre point;

FIG. 4, also discussed hereinbefore, schematically illustrates a robot moving an attached tool in such a way that the tool centre point should remain in the same position; and

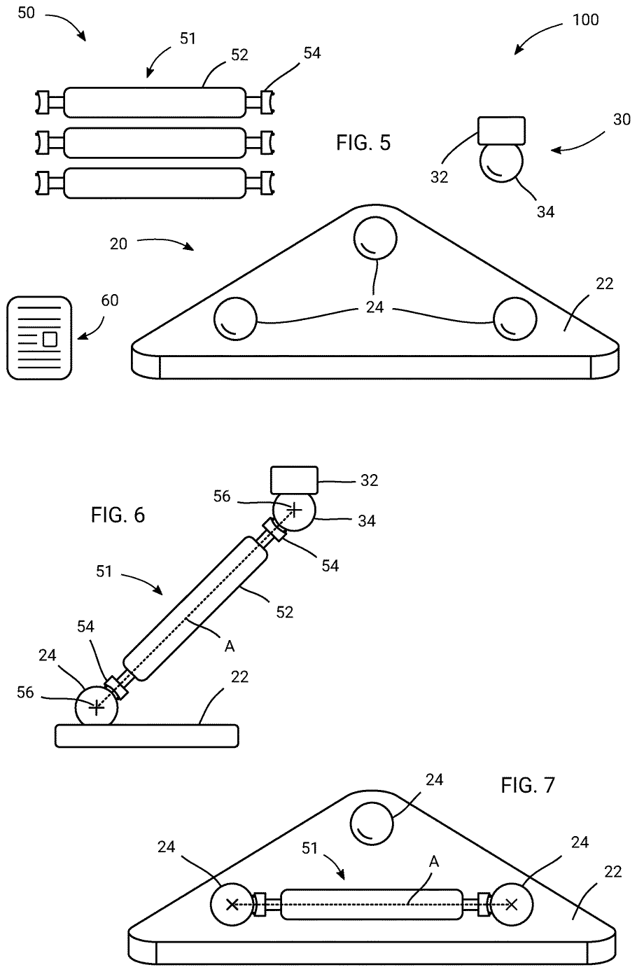

FIG. 5 shows a calibration kit for use in performing a joint offset calibration method according to an embodiment of the present invention;

FIG. 6 illustrates one of the measurement struts from the calibration kit of FIG. 5 coupled between two spherical mounts;

FIG. 7 illustrates one of the measurement struts from the calibration kit stowed away between two spherical mounts of the calibration artefact;

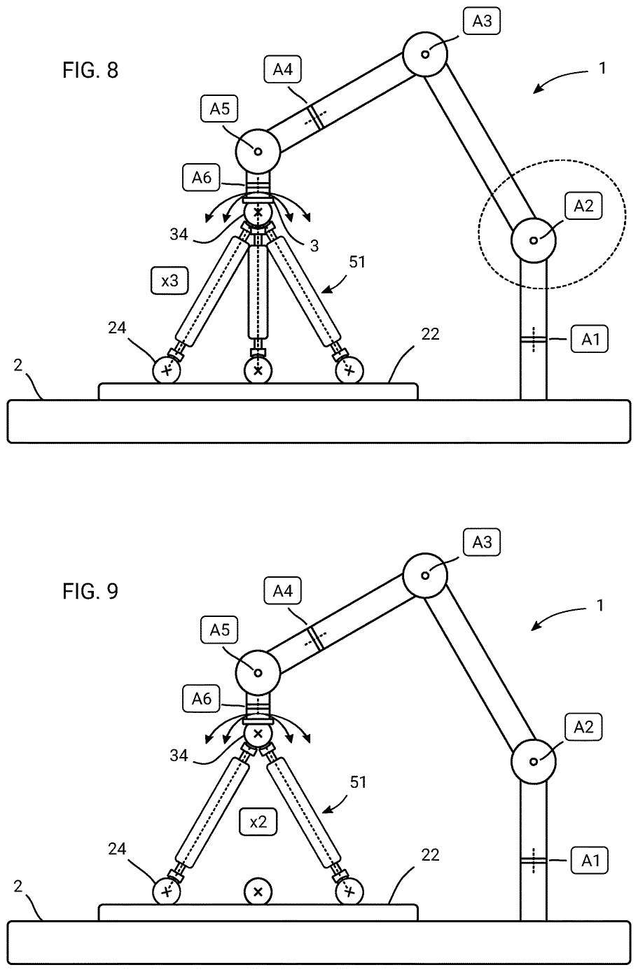

FIG. 8 illustrates all three measurement struts of the calibration kit coupled in a tripod configuration between the calibration artefact and the spherical mount on the end of a robot arm;

FIGS. 9 to 11 illustrate two of the three measurement struts coupled in different triangular configurations between the calibration artefact and the spherical mount on the end of the robot arm;

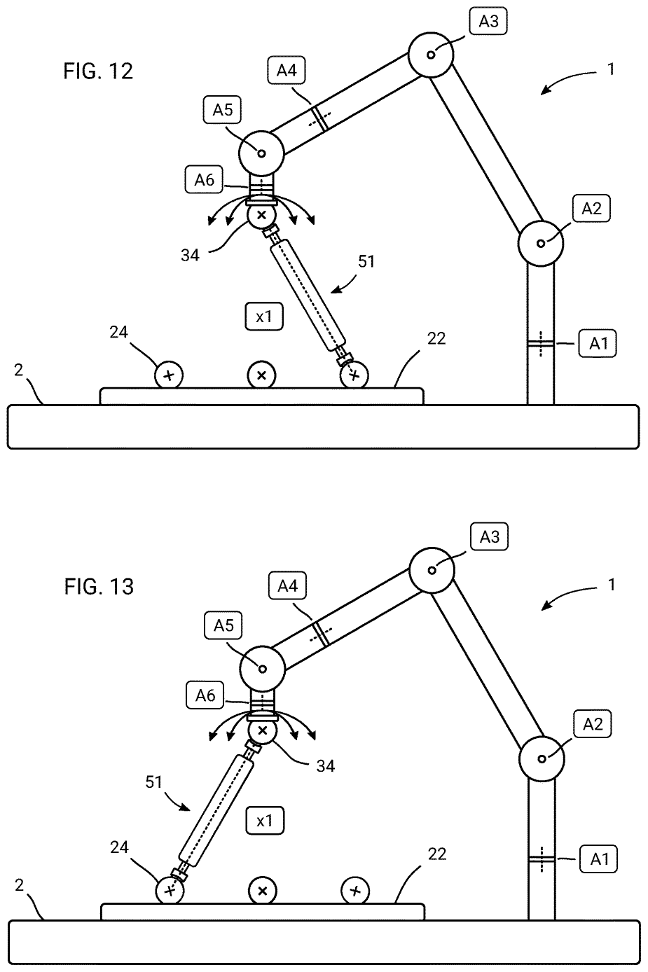

FIGS. 12 to 14 illustrate just one of the three measurement struts coupled in different configurations between the calibration artefact and the spherical mount on the end of the robot arm;

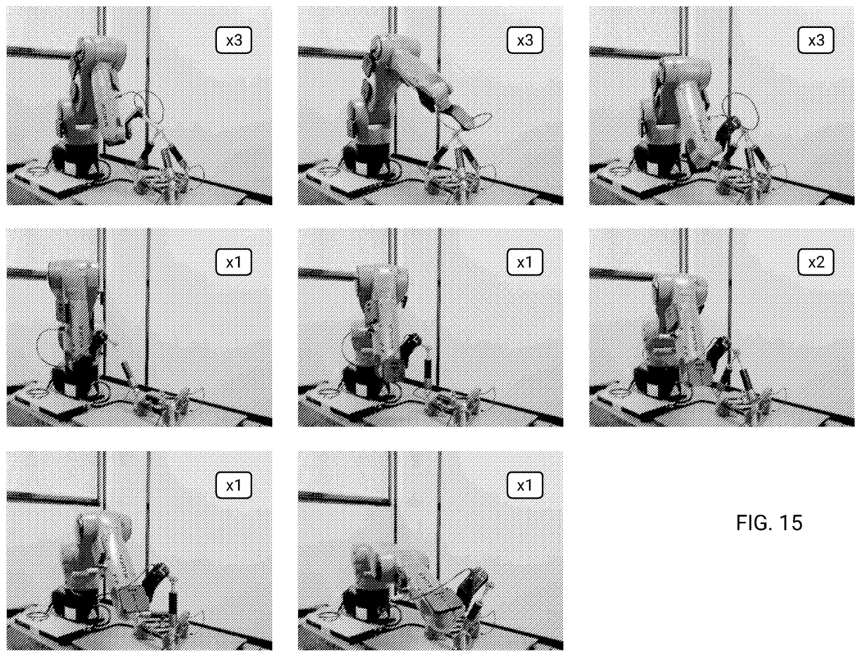

FIG. 15 shows a series of pictures of an actual robot arm performing the method shown schematically in FIGS. 8 to 14;

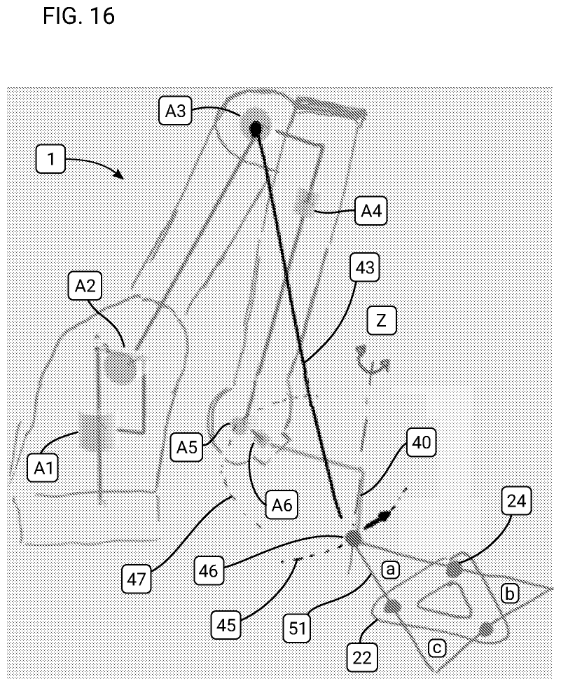

FIG. 16 illustrates a more detailed measurement strategy using a plurality of measurement struts;

FIG. 17 illustrates a calibration plate for calibrating the measurement strut;

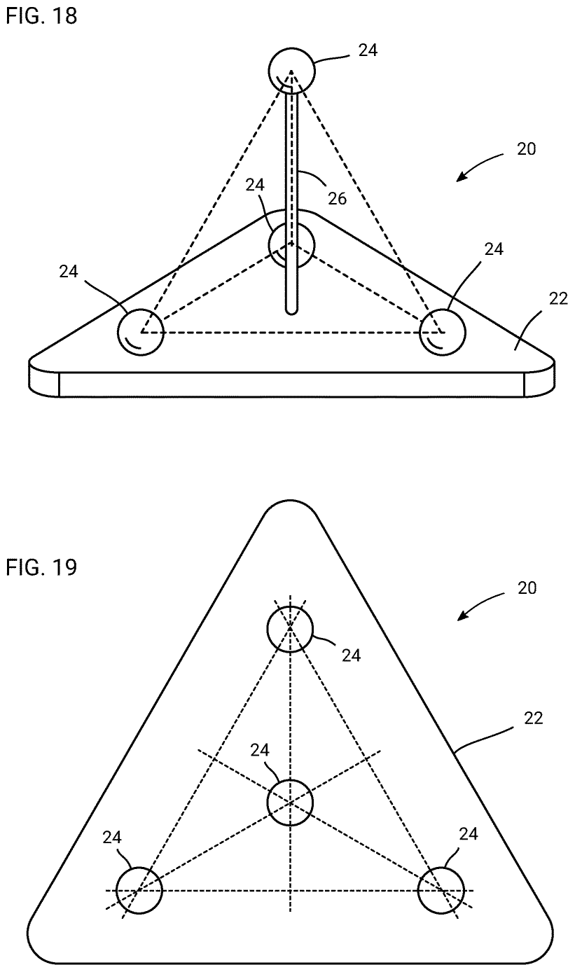

FIG. 18 shows a tetrahedral calibration artefact as an alternative to the planar calibration artefact of the previous embodiments;

FIG. 19 shows a plan view of the tetrahedral calibration artefact of FIG. 18;

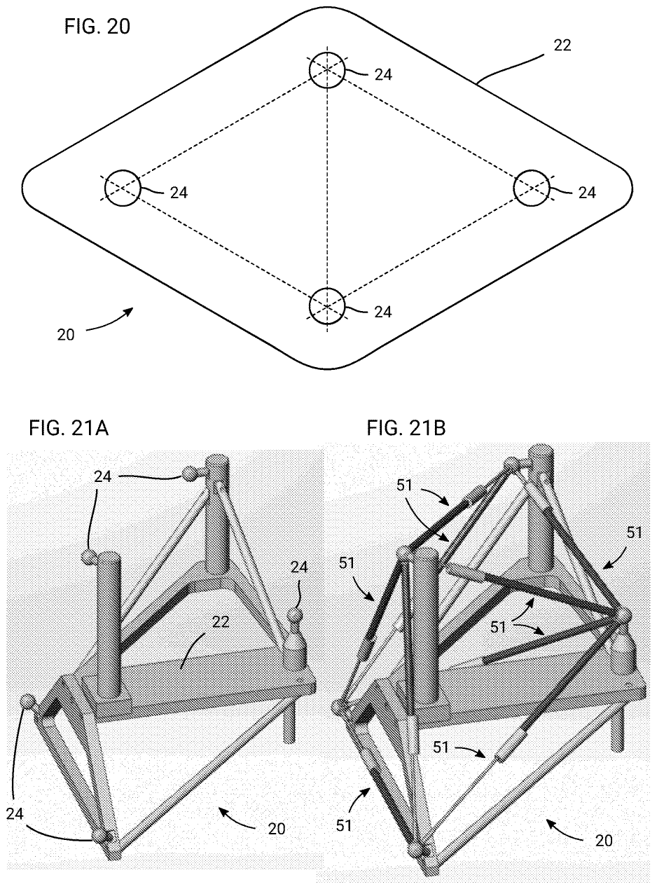

FIG. 20 shows a calibration artefact having an alternative arrangement of four supports compared to that shown in FIGS. 18 and 19;

FIGS. 21A and 21B illustrate a three-dimensional alternative to the tetrahedral arrangement of FIGS. 18 and 19;

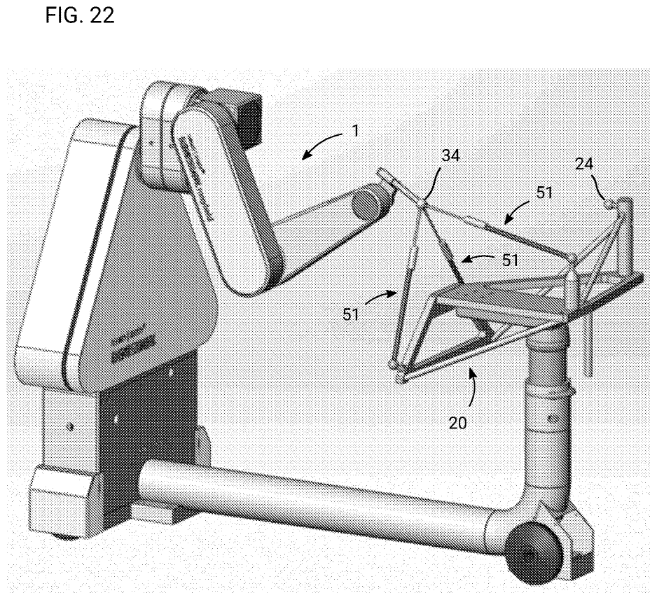

FIG. 22 shows a slight variant of the calibration artefact of FIGS. 21A and 21B in use to calibrate a robot arm;

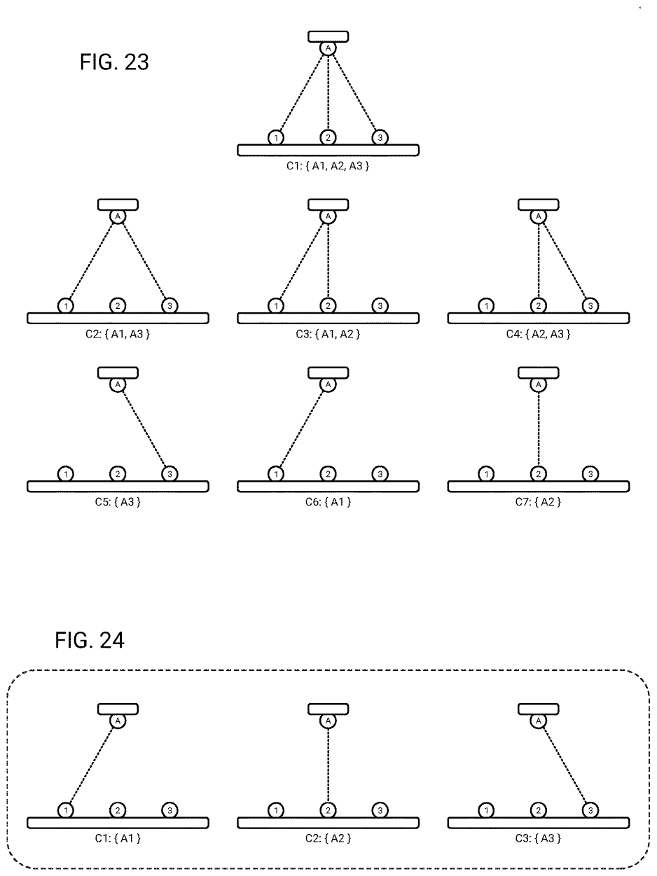

FIG. 23 is a schematic representation of the various strut configurations used in the embodiment of FIGS. 8 to 14;

FIG. 24 illustrates how a single strut can be coupled into three different configurations;

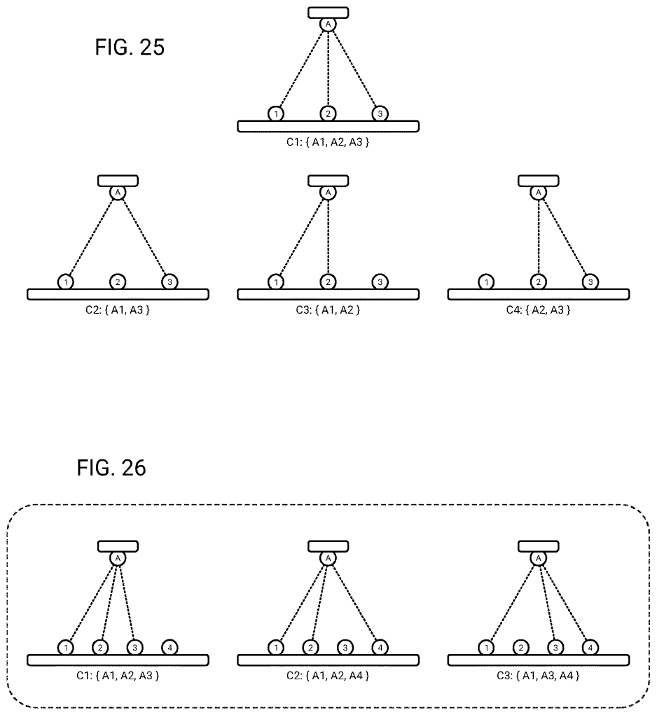

FIG. 25 is a schematic representation of the various strut configurations used in the embodiment described with reference to FIG. 16;

FIG. 26 is a schematic representation of the various strut configurations used in the embodiment described with reference to FIGS. 18 and 19;

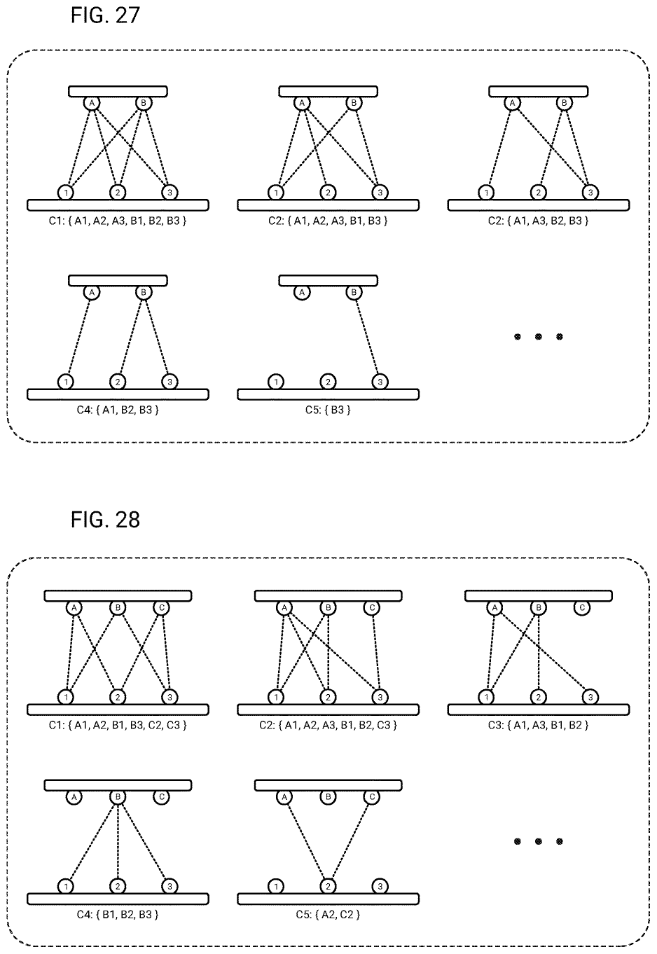

FIG. 27 shows some examples of strut configurations where the first member has two supports and the second member has three supports; and

FIG. 28 shows some examples of strut configurations where the first and second members both have three supports.

As noted above, calibration of the joint offsets of a robot arm is important. Liu et all (see above) proposes the use of a laser pointer attached to the end effector of a robot and a position-sensitive detector (PSD), with the laser being aimed towards the centre of the PSD surface from various positions and orientations of the robot.

The present applicant proposes a completely different approach to the determination of robot joint offsets, using a plurality of measurement struts (or ballbars) in different arrangements.

FIG. 5 shows a calibration kit 100 for use in performing a joint offset calibration method according to an embodiment of the present invention, comprising a first support arrangement 30, a second support arrangement 20, and a set 50 of three length-measuring measurement devices (for example in the form of three measurement struts or ballbars). Also shown schematically as being part of the calibration kit 100 is a set of instructions 60 explaining to the operator what manual steps are required to be carried out in a method embodying the present invention.

The first support arrangement 30, which comprises a base member 32 and a spherical support or ball or mount 34, is to be supported for example on the head end of the robot arm 1. The second support arrangement 20 comprises a rigid and substantially planar base plate 22 which supports three spherical supports or balls 24 in fixed positions relative to one another, for example to form an equilateral triangular arrangement. The second support arrangement 20 is also referred to herein as a calibration artefact 20.

As shown more clearly in FIG. 6, each length-measuring device 51 of the set 50 has a measurement body 52 as well as a coupling element 54 at each end. Each of the coupling elements 54 is adapted to couple to and bear against the bearing surface of a corresponding spherical support 24, 34 such that a measurement point 56 of the measuring device 51 is coincident with or is a known offset from the centre of the spherical support 24, 34, and remains so as the coupling element moves over at least a predetermined or working part of the bearing surface. In the example shown in FIGS. 5 and 6, each of the measurement struts 51 has a coupling element 54 at each end in the form of a kinematic cup, each of which couples to a corresponding spherical support 24, 34 as shown in FIG. 6. The kinematic cup used for each coupling element 54 can be seen more clearly in the measuring device 51 illustrated in FIG. 17.

FIG. 7 shows one of the measurement struts 51 of the set 50 coupled between two of the spherical supports 24. This allows the measurement struts 51 to be stowed away conveniently on the base plate 22 when not in use. However, when coupled between the spherical supports 24 as shown in FIG. 7 and activated to take a measurement, this also enables the separation between the spherical supports 24 (i.e. between the centre points of the spherical supports 24) to be measured. By measuring each of the three sides of the triangular arrangement of supports 24 in this way (either with three different measurement struts 51 of the set 50 or the same measurement strut 51), the geometry of the calibration artefact 20 can be fully characterised (three points will always lie in a plane, so all that is required is the length of each side). The measurement struts 51 themselves will be pre-calibrated but can be re-calibrated on site using a calibration plate like that for the QC-20W (ballbar) product from Renishaw plc, and as illustrated in FIG. 17. The calibration plate 62 is made of a material having a low coefficient of thermal expansion, such as Zerodur, and would have two cups 63 for receiving two spherical supports or balls 64 between which the strut 51 is coupled. This would be used for calibrating the “dead length” of the strut 51 (at one particular length), while calibration of the strut travel could be performed in advance using e.g. a laser calibration system such as the XL-80 product from Renishaw plc.

A method of calibrating or characterising at least one joint offset of a coordinate positioning machine will now be described with reference to FIGS. 8 to 14. The coordinate positioning machine is of a type as described above with reference to FIG. 2, having a first member (the flange 3) that is moveable relative to a second member (the fixed base 2), and wherein the geometry of the machine is characterised by a set of model parameters. As shown in FIG. 8, all three measurement struts 51 of the calibration kit 100 as described above are initially coupled in a tripod arrangement or configuration between the spherical support 34 (mounted on the first member, i.e. the flange 3, of the robot arm 1) and different respective ones of the spherical supports 24 of the calibration artefact 20 (which is mounted on the second member, i.e. the fixed base 2). The base member 32 of the first support arrangement 30 is not shown for simplicity. The spherical support 34 on the robot arm 1 can conveniently be an adaptor as described in WO 2019/162697 A1 (see, for example, FIGS. 16 to 30 of that document). To avoid clashing, coupling elements 54 that are offset to one side of the longitudinal axis A of the measurement strut 51 may be used, for example as described in WO 2023/037110 A1.

The controller 8 (not shown in FIG. 8, but see FIGS. 1, 2 and 5) is used to control the robot 1 to make a sequence of movements in this configuration, for example rotational movements nominally around a fixed point. The robot 1 is controlled to stop at each of a plurality of discrete positions, at each of which measurements from the three measurement struts 51 are recorded as calibration data (along with the machine coordinates when the measurements were made). As mentioned above, the tool centre point 46 is the point in relation to which all robot positioning is defined, so rotation of the robot 1 around a fixed point in this context means rotation around the tool centre point 46, with the tool centre point 46 remaining stationary (at least for an ideal calibration).

Where the measurement point 56 is coincident with the tool centre point 46, for example by using an adaptor as described in WO 2019/162697 A1, when the movements are nominally around a fixed point the measurements from the three struts 51 should ideally all be constant, and any deviations (or errors) from that expectation will enable the machine parameters (or model parameters) to be updated to provide a better estimate of the machine parameters (using known error minimisation methods as mentioned above). This applies similarly to movements which are expected to result in changes in the length of each of the three struts 51, in which case the optimisation would be based on a comparison (or difference or error) between the expected lengths and the measured lengths.

In FIG. 8, because of a potentially limited range of travel for each measurement strut 51, movements are mainly restricted to rotations around the apex of the tripod arrangement or configuration, and relatively small translational movements that are within range of the tripod arrangement or configuration. However, the modular design of the calibration kit 100 conveniently enables one of the measurement struts 51 to be removed, thereby leaving just two measurement struts 51 in a triangular arrangement or configuration, as shown in FIG. 9. This different configuration of measurement struts 51 now enables a much greater range of movement for the robot 1, for example in a wide vertical arc from one side to the other. In doing so, the joints of the robot 1 experience a greater range of movement, and accordingly the calibration will be better. The use of arrows (representing movement) that are of the same position, size and shape (compare FIGS. 8 and 9) does not imply that the same movements are made, because these are purely schematic in nature; in fact the opposite is true because a much wider range of movements is made with the configuration shown in FIG. 9 as mentioned above.

Performing a calibration routine based only on the types of movement that are possible with the tripod arrangement of FIG. 8 will not be optimal for calibration of joint offsets, particularly those of the lower robot joints (i.e. closer to the base end) e.g. A2, A3 circled in FIG. 8, because these joints are not used much due to limited range of travel at the apex of the tripod. By expanding the range of movement with only two measurement struts 51 attached, the range of movements of these lower joints can be expanded, leading to a better calibration of these joint offsets. The present applicant has noted that calibration of the joint offset for axis A2 is particularly problematic, and a method embodying the present invention is particularly beneficial in respect of this joint offset.

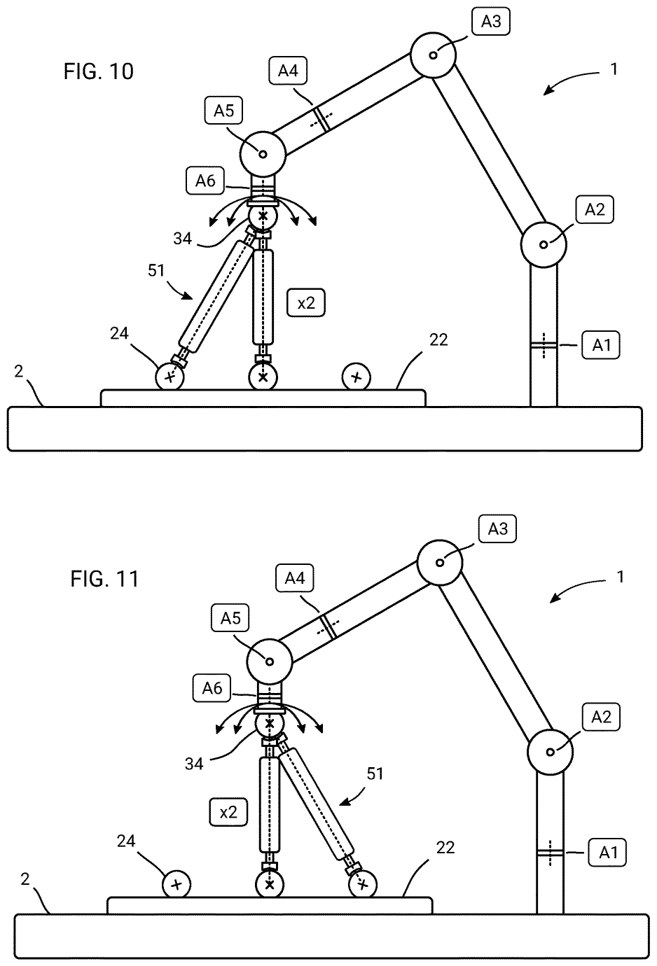

Measurements from the two measurement struts 51 are recorded as calibration data (again, along with the corresponding machine coordinates), and when the measurements are taken with the measurement point 56 being moved nominally along a circular arc, the measurements from the two struts 51 should ideally both be constant. This can be repeated for a pair of measurement struts 51 coupled in a different triangular configuration between two different corresponding pairs of spherical supports 24 on the calibration artefact 20, as shown in FIGS. 10 and 11. These are considered to be different configurations of measurement struts 51, since a different configuration in this context can be understood as meaning a different number of measurement struts 51 or the same number of measurement struts 51 but coupled between a different pair of supports 24, 34 (this will be explored in more detail below with reference to FIGS. 23 to 28). Again, any deviations (or errors) from the expectation that the measurements from the two struts 51 will be constant will enable the machine parameters (or model parameters) to be updated to provide a better estimate of the machine parameters (using known error minimisation methods as mentioned above).

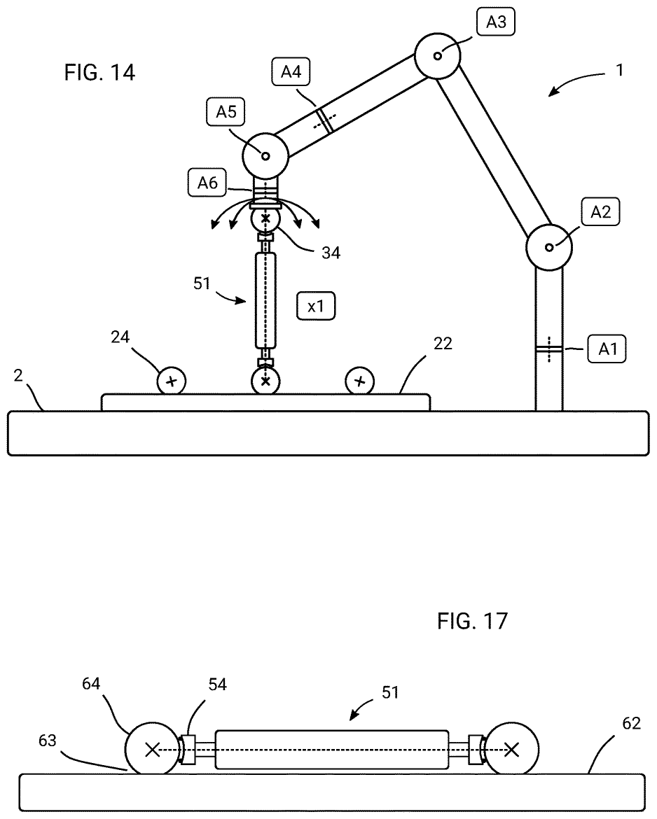

FIG. 12 goes one step further, by removing another measurement strut 51 to leave just one of the three measurement struts 51 coupled between the calibration artefact 20 and the spherical support 34 on the end of the robot arm 1. This configuration allows an even greater range of movement for the robot 1, and in particular for the joints of the robot 1, and more particularly for the lower joints such as that associated with axis A2. This can be repeated, to collect more calibration data, with the single strut 61 coupled between the support on the robot arm 1 and the other two supports 24 on the calibration artefact 20, as shown in FIGS. 13 and 14 (these all count as different configurations of the measurement struts 51). Measurements from the single measurement strut 51 are recorded as calibration data (along with the corresponding machine coordinates), and when the measurement point 56 is being moved nominally along a spherical surface, the measurements from the strut 51 should ideally be constant. Again, any deviations (or errors) from that expectation will enable the machine parameters (or model parameters) to be updated to provide a better estimate of the machine parameters (using known error minimisation methods as mentioned above).

A method embodying the present invention enables calibration data to be gathered for measurements taken with one, two or three measurement struts 51 attached, or a combination of two or more of these. When two measurement struts 51 are used, these may be coupled between any of three different pairs of spherical supports 24 on the base plate 22, each counting as a different configuration, and similarly when only one measurement strut 51 is used, and calibration data can be gathered for these alternative configurations and used in the error minimisation routine to determine a better estimate for the machine parameters and in particular the joint offsets, leading to a better characterisation of the geometry of the machine.

These concepts as described with reference to the schematic illustrations of FIGS. 8 to 14 are shown in operation on an actual robot arm in FIG. 15, with the robot arm being shown performing movements with three (x3) then two (x2) then one (x1) measurement strut attached.

FIG. 16 illustrates a more specific calibration strategy using a plurality of measurement struts 51 to enable robust identification of robot's joint offsets (or axis offsets). The proposed strategy includes indications as to where to place the tripod base, as well as positions, orientations and configurations are chosen to take measurements.

There are thirteen parameters to identify when calibrating joint offsets according to this proposed strategy:
the joint offsets of axes A2, A3, A4 and A5
the tool centre point (TCP)
the tripod base position and orientation

To define the proposed strategy, groups of positions are identified that will enable parameters to be isolated (like when flipping the direction of a parameter), and the strategy can be validated with a Monte-Carlo simulation (parameter errors and stability, correlations and positioning errors can be validated in an ISO test).

A series of robot positions has been found that correctly decorrelates the parameters of the calibration. The efficiency of this strategy is dependent on the initial choice of the position of the tripod. It has been found that this series of positions should preferably be replicated in various configurations to avoid corruption from non-calibrated (e.g. Denavit-Hartenberg) robot parameters.

The proposed strategy has been tested with Monte-Carlo simulations and it provides good results both when calibrating the offset of axis A2 (with reversing of the configuration of axis A1) and when not calibrating it.

The proposed strategy is as follows:
(a) Drive the robot 1 to the “folded” position. In this position, the elbow (at axis A3) is somewhere above the TCP 46 and the tool 40 is oriented to offset the TCP 46 horizontally away from axis A1 as far as possible. Line 43 is marked between the elbow (axis A3) and the TCP 46, whereby the TCP 46 would move along arc 45 if axis A3 were to be actuated in this position.
(b) Position the tripod base 22 so that the TCP 46 of the “folded” position is in the lower triangle “a” closest to the robot 1.
(c) When at the lower triangle “a” closest to the robot 1 (in the “folded” position), with two struts 51 coupled between the base 22 and the TCP 46 in a triangular configuration, take two measurements when rotating around the Z axis, such that axis A5 moves along arc 47, and thereby seeking a maximum rotation for axis A1.
(d) Perform translations to reach the main position (summit of the tripod) and take the first measurement with three struts 51 coupled in a tripod configuration.
(e) While in the main position (summit of the tripod), take six measurements when rotating around X, Y and Z (seek ±90°) with three struts 51 coupled between the base 22 and the TCP 46 in a tripod configuration.
(f) Take one measurement in each lower triangle “a”, “b” and “c” of the tripod base (i.e. with two struts 51 coupled between the base 22 and the TCP 46 in three different configurations, each of which is different to the tripod configuration).
(g) Move the robot 1 back to the main position (summit of the tripod) after reversing the configuration of axis A5 and take a measurement with three struts 51 coupled between the base 22 and the TCP 46 in a tripod configuration.
(h) While in the main position (summit of the tripod), take three measurements when rotating around X, Y and Z (seek 90°) with three struts 51 coupled between the base 22 and the TCP 46 in a tripod configuration.
(i) If possible, move the robot 1 into a pose in which axis A1 is backward, move back to the main position (summit of the tripod) and take a measurement with three struts 51 coupled between the base 22 and the TCP 46 in a tripod configuration.
(j) While in the main position (summit of the tripod), take three measurements when rotating around X, Y and Z (seek 90°) with three struts 51 coupled between the base 22 and the TCP 46 in a tripod configuration.

It will be appreciated that other alternatives are possible within the scope of the overall concept as described herein. For example, although the above-described embodiments have a single moveable support 34 (moving with the flange 3 of the robot 1) and a triangular arrangement of fixed supports 24 (fixed to the base 2 of the robot 1), it will be appreciated that this can be reversed so that the triangular arrangement of supports 24 is instead mounted to the flange 3 of the robot 1 and the single support 34 is mounted to the base 2 of the robot 1.

A different number of fixed supports and moveable supports could also be used, i.e. other than a 1-3 arrangement of one moveable and three fixed supports or a 3-1 arrangement of three moveable and one fixed support. For example, a 3-2 or 2-3, 3-3, 2-4 or 4-2 arrangement could be used, with a corresponding number of measurement struts 51 being provided in the set 50. With a 3-3 arrangement, there would be six measurement struts 51 being provided in the set 50, using anything between one and six measurement struts 51 at any one time in different configurations. In general, it has not previously been proposed to the use a plurality of measurement struts, in a flexible manner, to calibrate or otherwise characterise joint offsets of a coordinate positioning machine such as a robot arm.

It will be appreciated that, although it can often be desirable to use different numbers of measurement struts 51 in different configurations during the course of carrying out a calibration or characterisation method embodying the present invention, it is also possible to use the same number of measurement struts 51 in all of the different configurations. A configuration can be understood as being defined by a combination of the number of measurement struts 51 used in the configuration and the particular pairs of supports 24, 34 between which the measurement struts 51 are coupled in the configuration. For example, the example described above with reference to FIGS. 8 to 14 uses between one and three measurement struts 51 in each configuration, and for those configurations that share the same number of measurement struts 51, a different combination of supports 24, 34 are used. On the other hand, the example described above with reference to FIG. 16 uses three measurement struts 51 in a tripod configuration, but also uses two measurement struts 51 in three different triangular configurations with each of these being based on a different combination of supports 24, 34 (to create the triangles “a”, “b” and “c” mentioned above). For more discussion on this, see the description below with reference to FIGS. 23 to 28.

It would also be possible to use a tripod arrangement of measurement struts 51 in all configurations, but using e.g. a tetrahedral arrangement of four supports 24 on the calibration artefact 20 (rather than a triangular arrangement of three supports 24 as described previously). This would enable a tripod arrangement of measurement struts 51 to be coupled between different combinations of supports 24, 34 to create the different configurations, with calibration data being collected in each of these configurations as described previously. With such an embodiment it would not be necessary (though it could still help) to use any configurations in which the number of measurement struts 51 is two or one.

A tetrahedral calibration artefact 20 as mentioned above is shown in FIG. 18, with FIG. 19 showing a plan view thereof. As with the previous embodiments, the tetrahedral calibration artefact 20 comprises a rigid and substantially planar base plate 22 which supports three spherical supports 24 in a fixed triangular arrangement. The tetrahedral calibration artefact 20 also comprises a post or pillar 26 extending upwardly from the base plate 22 which supports a fourth spherical support 24 so as to create a tetrahedral arrangement of supports 24. This non-planar (or three-dimensional) arrangement of supports 24 differs from the previously-described planar arrangement (or two-dimensional) arrangement of supports 24, and effectively creates three base triangles at different angles to one another. The measurement struts 51 can be coupled to robot 1 in a tripod arrangement as per the previous description, but now this can be repeated for each of the three different configurations (associated respectively with the three base triangles), performing a variety of movements for each to collect the calibration data for optimisation routine. This results in calibration data being collected for a greater range of movement in the problematic joints described previously (e.g. A2, A3 circled in FIG. 8), and therefore a better calibration of the associated joint offsets. Furthermore, the separation between pairs of supports 24 of the tetrahedral calibration artefact 20 can be measured in a similar manner to what is described above by connecting a measurement strut 51 between each pair in turn, thereby enabling the geometry of the tetrahedral calibration artefact 20 to be characterised (and with the position and orientation of each base triangle being known relative to each other).

As an alternative to a tetrahedral arrangement of four supports 24 as shown in FIGS. 18 and 19, a substantially flat or planar arrangement of four supports 24 could instead be used as shown in FIG. 20. With the calibration artefact 20 of FIG. 20, fourth support 24 has been mounted directly to the same base plate 22 as the others. However, this would be less preferred than the tetrahedral arrangement because, due to deformations in the plate 22 (e.g. when bolted down to the base 2), it could happen that while three of the balls will of course lie in a plane the other one may not be in the same plane. It is not easily possible to measure the height of the other ball using the struts 51, and an external calibration (e.g. using an independent CMM) may need to be performed. The three-dimensional tetrahedral arrangement of four balls (as shown in FIG. 18) enables the geometry of the artefact 20 to be characterised completely using the struts 51 themselves.

An alternative to the tetrahedral arrangement of FIGS. 18 and 19 is shown in FIGS. 21A and 21B. The calibration artefact 20 of FIGS. 21A and 21B comprises five supports 24. A base framework 22 is suitably adapted for mounting the supports 24 in a predetermined fixed spatial relationship relative to one another so as to create five base triangles at different angles to one another. These base triangles are clearly apparent in FIG. 21B, which shows a measurement strut 51 coupled between each of nine different pairs of supports 24 to define the five base triangles, and to characterise the overall geometry of the calibration artefact 20 as described above. The measurement struts 51 can then be coupled in five different tripod configurations for the calibration routine, thereby exercising the various joints sufficiently (via the movements performed when in each of the different tripod configurations) to provide a rich set of calibration data for the optimisation routine. FIG. 22 shows a slight variant of the calibration artefact 20 of FIGS. 21A and 21B in use to calibrate the robot 1, with one of the tripod configurations of measurement struts 51 in place.

What is meant by a “configuration” in the context of an embodiment of the present invention will now be explained in more detail with reference to the schematic diagrams of FIGS. 23 to 28. Starting with FIG. 23, this shows a schematic representation of seven different configurations C1 to C7 that correspond respectively to those of FIGS. 8 to 14. The single support mounted on the first (upper, moveable) member of the machine is denoted as support A, while the three supports mounted on the second (lower, fixed) member of the machine are denoted respectively as supports 1, 2 and 3. In configuration C1 there are three measurement struts coupled respectively: (a) between support A and support 1 (denoted as A1); (b) between support A and support 2 (denoted as A2); and (c) between support A and support 3 (denoted as A3). Accordingly, configuration C1 can be denoted as {A1, A2, A3} . Similarly, configuration C2 can be denoted as {A1, A3} , and so on. The make-up of each configuration is marked on FIG. 23.

Accordingly, each different configuration is defined by a different combination of supports, whether that be due to a different number of struts in the configuration or the same number of struts but coupled between different respective pairs of supports, or a combination of these. It is important to note that configuration C1 is not in general equivalent to a combination or union of configurations C5, C6 and C7, because different movements would in general be made by the machine in each of these configurations. However, if it is specifically arranged that the same movements are made by the machine for each of the configurations C5, C6 and C7, then this would be considered to be equivalent to making those movements with configuration C1 (since the same measurements would be recorded for the calibration data). Then, additional (and different) movements could be made individually for each of the configurations C5, C6 and C7 (i.e. different to the movements made for the combination of C5, C6 and C7 that replicates C1), so each of these is also considered to be a different configuration in its own right because they each produce different measurements for the calibration data. Similarly, configuration C2 is not in general equivalent to a combination or union of configurations C5 and C6, but if it is specifically arranged that the same movements are made by the machine for each of the configurations C5 and C6, then this would be considered to be equivalent to making those movements with configuration C2. In this way, it would be possible to use a single measurement strut (or two measurement struts) to form all of the configurations C1 to C7 shown in FIG. 23, though this would of course lengthen and complicate the calibration procedure compared to using three measurement struts.

In another embodiment, just one measurement strut 51 could be coupled into different configurations between different pairs of supports 24, 34 (i.e. without using any configuration which has two or more measurement struts 51). This is shown schematically in FIG. 24, which uses the same scheme to denote the three configurations C1 to C3 as was used with reference to FIG. 23 (and hence a detailed further explanation is not required). This embodiment differs from what has been proposed previously in “Absolute robot calibration with a single telescoping ballbar” by Albert Nubiola and Ilian Bonev (Precision Engineering, Volume 38, Issue 3, July 2014, Pages 472-480), because in that proposal it was suggested to couple a single ballbar between different pairs of supports, but to move between the same set of machine poses for each ballbar. This merely amounts to using a single ballbar to create a hexapod arrangement, and is therefore just a single (hexapod) configuration of ballbars (see the above discussion with reference to FIG. 23). In an embodiment of the present invention a plurality of different configurations is used, and the machine is not constrained to move between the same poses in each configuration. There is no requirement that in each pose the measurement strut 51 is capable of being coupled between all pairs of supports at same time (i.e. within the normal measurement range of the measurement strut 51). This enables more extreme machine moves to be made, not constrained by the limited range of available movement/measurement created by a combination of all six struts, and thereby leads to an improved overall calibration.

It should be noted that the separations between the three supports mounted on the second (lower, fixed) member in FIG. 24 do not need to be known (as described above for the tetrahedral calibration artefact 20 of FIG. 18), or in other words the geometry of the artefact does not to be known. For example, for each configuration it would be sufficient to make movements around the upper support, nominally keeping that support in a constant position while rotating the first member around between different measurement positions, knowing that the measurements from the measurement strut should be constant and being able to update the calibration if they are not (i.e. to fit the measurement data better). This does not require the separation between the lower supports to be known, and it is merely sufficient to know that each lower support is in a fixed position. It may speed up the calibration process if those separations are known, but it is not essential. Indeed, this applies to all embodiments described herein.

FIG. 25 shows a schematic representation of four different configurations C1 to C7 that correspond to those used in the embodiment described above with reference to FIG. 16. Configuration C1 is that which is used for measurement taken in the main position (summit of the tripod), while configurations C2, C3 and C4 are those which are used respectively in the lower triangles “a”, “b” and “c” of the tripod base. Again, as described above, this could be replicated using just one or two measurement struts.

FIG. 26 shows a schematic representation of four different configurations C1 to C7 that correspond to those used in the embodiment described above with reference to FIGS. 18 and 19. The tetrahedral arrangement of four supports is represented schematically in FIG. 26 by a linear arrangement of supports, with support 1 on the second (lower, fixed) member corresponding to the middle (raised) support 24 shown in FIGS. 18 and 19. This is an example where each of the three different configurations C1 to C3 has the same number of measurement struts but coupled between different respective pairs of supports. Again, as described above, this could be replicated using just one or two measurement struts.

FIG. 27 shows an example in which the first (upper, moveable) member of the machine is provided with two supports denoted respectively as A and B, with the second (lower, fixed) member having three supports denoted respectively as 1, 2 and 3. Five representative configurations C1 to C5 are illustrated by way of example, with configuration C1 being defined by six measurement struts in a combination denoted as {A1, A2, A3, B1, B2, B3}. Configuration C2 drops one of these pairs (that denoted as B2) to leave {A1, A2, A3, B1, B3}, and so on through to configuration C5 which has just one strut denoted as {B3}. Calibration data would be collected in each of these configurations, and there may be more configurations used, hence the ellipsis (three dots) in FIG. 27. Again, as described above, these configurations could be replicated using fewer than five measurement struts (even a single measurement strut).

FIG. 28 shows an example in which the first (upper, moveable) member of the machine is provided with three supports denoted respectively as A, B and C, with the second (lower, fixed) member having three supports denoted respectively as 1, 2 and 3. Five representative configurations C1 to C5 are illustrated by way of example, with configuration C1 being defined by six measurement struts in a combination denoted as {A1, A2, B1, B3, C2, C3}. This is a hexapod configuration of struts. Configuration C2 rearranges these six struts into a different configuration {A1, A2, A3, B1, B2, C3}. Configuration C3 uses only four struts and is denoted as {A1, A3, B1, B2}, while configuration C4 uses three struts arranged as {B1, B2, B3} and configuration C5 uses just two struts arranged as {A2, C2}. Calibration data would be collected in each of these configurations, and there may be more configurations used, hence the ellipsis (three dots) in FIG. 28. Again, as described above, these configurations could be replicated using fewer than six measurement struts (even a single measurement strut).

It will be appreciated that the various configurations illustrated in FIGS. 23 to 28 are merely representative and are not intended to be limiting. For example, a different number of supports could be used on the first and/or second member to what is illustrated, and different combinations of these supports could be used to form a different set of configurations to what is shown. For the set of configurations illustrated in FIG. 24, it could for example be the case that only two supports are provided on the second (lower, fixed) member, so that there are only two possible configurations: configuration C1 with a single strut arranged as {A1} and configuration C2 with a single strut arranged as {A2}.

The calibration data collected during the performance of a method embodying the present invention comprises measurements (e.g. lengths or separations, or changes thereto) from the measurement struts. The calibration data also comprises information which reflects or represents the (recordable) state of the machine when each of the measurements was taken. This type of information (forming part of the calibration data) can be referred to as machine coordinates (or machine coordinate data), which in this context is intended to mean a set of coordinates or values representing the state of the machine (e.g. encoder readings for each joint) for a particular machine pose. In this respect, the various physical motion axes of a machine, such as the linear axes defined by the extendible legs of a hexapod machine or the rotary axes of an articulated robot arm, can be considered herein to define a machine coordinate system, hence the term machine coordinates.

It will be appreciated that the present invention can be applied not only to calibration of a machine, but also to verification, certification, or performance checking of a machine. The terms calibration method, calibration artefact, calibration member, calibration data, calibration point and so on used herein should be interpreted accordingly in a broad sense, depending on the intended application, and not limited only to calibration as such. In other words, the concepts described herein apply not only to updating of the model parameters (calibration) but also checking or verification of the model parameters (verification or certification). Accordingly, these terms should be understood in the context of calibrating or otherwise characterising the machine. As one example, the term calibration artefact includes within its scope a gauge artefact. The terms target point, target artefact and target member could be used instead of calibration point, calibration artefact and calibration member respectively.

A machine controller for controlling the operation of the coordinate positioning machine may be a dedicated electronic control system and/or may comprise a computer operating under control of a computer program. For example, the machine controller may comprise a real-time controller to provide low-level instructions to the coordinate positioning machine, and a PC to operate the real-time controller. It will be appreciated that operation of the coordinate positioning machine can be controlled by a program operating on the machine, and in particular by a program operating on a coordinate positioning machine controller such as the controller 8. Such a program can be stored on a computer-readable medium, or could, for example, be embodied in a signal such as a downloadable data signal provided from an Internet website. The appended claims are to be interpreted as covering a program by itself, or as a record on a carrier, or as a signal, or in any other form.

1. A method of calibrating or otherwise characterising a coordinate positioning machine having a first member that is moveable relative to a second member, wherein the geometry of the machine is characterised by a set of model parameters, and wherein the method comprises: (a) coupling one or more length-measuring devices in a plurality of different configurations between at least one support mounted on the first member and a plurality of supports mounted on the second member; (b) for each of the plurality of configurations, controlling the machine to move the first member relative to the second member to collect calibration data; and (c) using the calibration data to determine a better estimate for at least one of the model parameters.

2. The method as claimed in claim 1, wherein each configuration comprises one or more length-measuring devices coupled between a different combination of supports to each other configuration.

3. The method as claimed in claim 1, wherein at least one configuration comprises a different number of length-measuring devices to at least one other configuration.

4. The method as claimed in claim 1, wherein at least one configuration comprises the same number of length-measuring devices to at least one other configuration but coupled between a different combination of supports.

5. The method as claimed in claim 1, wherein the relative movements between the first and second members performed for each configuration are different to those performed for at least one other configuration.

6. The method as claimed in claim 1, wherein the model parameters comprise at least one joint offset, and wherein step (c) comprises using the calibration data to determine a better estimate for the at least one joint offset.

7. The method as claimed in claim 1, wherein at least one configuration is made up of a plurality of length-measuring devices which are coupled between the relevant supports at the same time.

8. The method as claimed in claim 1, wherein at least one configuration is made up of a plurality of length-measuring devices at least two of which are coupled between the relevant supports at different times, with the same movements being made for each of these length-measuring devices.

9. The method as claimed in claim 1, wherein step (a) comprises coupling up to three length-measuring devices in a plurality of different configurations between a single support mounted on the first member and a triangular arrangement of supports mounted on the second member.

10. The method as claimed in claim 1, wherein step (a) comprises coupling up to six length-measuring devices in a plurality of different configurations between a triangular arrangement of supports mounted on the first member and a triangular arrangement of supports mounted on the second member.

11. The method as claimed in claim 1, wherein at least one of the configurations comprises two or more length-measuring devices coupled between the supports.

12. The method as claimed in claim 1, wherein at least one of the configurations comprises more than one length-measuring device and fewer than six length-measuring devices coupled between the supports.

13. The method as claimed in claim 1, wherein at least one of the configurations comprises fewer than three length-measuring devices coupled between the supports.

14. The method as claimed in claim 1, wherein at least one of the configurations comprises a single length-measuring device coupled between the supports.

15. The method as claimed in claim 1, wherein each of the configurations comprises a single length-measuring device coupled between the supports.

16. The method as claimed in claim 1, wherein at least one of the configurations comprises two length-measuring devices coupled at the same time between the supports.

17. The method as claimed in claim 1, wherein at least one of the configurations comprises three length-measuring devices coupled at the same time between the supports.

18. The method as claimed in claim 1, wherein, where there is more than one support mounted on the relevant member, the supports are mounted in a fixed position relative to one another.

19. The method as claimed in claim 18, wherein the relative positions between the supports are measured using another coordinate measuring machine and wherein this relative positional information is used in step (c).

20. The method as claimed in claim 18, comprising measuring the relative positions between the supports using one or more of the length-measuring devices.

21. The method as claimed in claim 18, wherein the supports are arranged relative to one another such that the geometry of the arrangement of supports can be characterized by measurements between different pairs of the supports that are within a measuring range of the length-measuring devices used in the method.

22. The method as claimed in claim 18, wherein the supports are mounted in a non-planar arrangement relative to one another, for example in a tetrahedral arrangement.

23. The method as claimed in claim 1, wherein each length-measuring device is adapted to provide a measurement of the separation between two measurement points of the device.

24. (canceled)

25. The method as claimed in claim 1, wherein each support has an at least part-spherical bearing surface and wherein each length-measuring device has a coupling element at each end which is adapted to couple to and bear against the bearing surface of the corresponding support, such that a measurement point of the measuring device is coincident with or is a known offset from the centre of the at least part-spherical bearing surface, and remains so as the coupling element moves over at least a predetermined or working part of the bearing surface.

26.-27. (canceled)

28. The method as claimed in claim 1, wherein each length-measuring device is a measurement strut or ballbar.

29.-31. (canceled)

32. The method as claimed in claim 1, wherein the coordinate positioning machine is a robot arm.

33.-36. (canceled)

37. The method as claimed in claim 1, wherein step (c) comprises determining a new set of model parameters which would fit the calibration data better than the existing set of model parameters, for example based on an objective function.

38.-41. (canceled)

42. The method as claimed in claim 1, wherein step (c) comprises determining a new value or new values for only a subset of the model parameters.

43.-44. (canceled)

45. A kit for use in a method as claimed in claim 1, the kit comprising one or more length-measuring devices, a first support arrangement comprising the at least one support to be mounted on the first member of the machine, and a second support arrangement comprising the plurality of supports to be mounted on the second member of the machine.

46.-48. (canceled)

49. A computer-readable medium having stored therein computer program instructions for controlling a computer or a machine controller to perform one or more steps of a method as claimed in claim 1, for example one or both of steps (b) and (c).

50.-53. (canceled)
